(19) United States
(12) Patent Application Publication
(10) Pub. No.: US 2012/0188259 A1
(43) Pub. Date: Jul. 26, 2012

(54) Mechanisms for Enabling Task Scheduling

(75) Inventors: Robert Scott Hartog, Windermere, FL (US); Ralph Clay Taylor, Deland, FL (US); Michael Mantor, Orlando, FL (US); Thomas Woller, Austin, TX (US); Kevin McGrath, Los Gatos, CA (US); Sebastien Nussbaum, Lexington, MA (US); Nuwan Jayasena, Sunnyvale, CA (US); Rex McCrary, Oviedo, FL (US); Philip Rogers, Pepperell, MA (US); Mark Leather, Los Gatos, CA (US)

(73) Assignee: Advanced Micro Devices, Inc., Sunnyvale, CA (US)

(21) Appl. No.: 13/303,722

(22) Filed: Nov. 23, 2011

Related U.S. Application Data
(60) Provisional application No. 61/422,608, filed on Dec. 13, 2010.

(51) Int. Cl. G06T 1/20

(52) U.S. Cl. 345/503

(57) ABSTRACT

Embodiments described herein provide a method including receiving a command to schedule a first process and selecting a command queue associated with the first process. The method also includes scheduling the first process to run on an accelerated processing device and preempting a second process running on the accelerated processing device to allow the first process to run on the accelerated processing device.

### CROSS-REFERENCE TO RELATED APPLICATIONS

This application claims the benefit of U.S. Provisional Application No. 61/422,608, filed Dec. 13, 2010, which is incorporated by reference herein in its entirety.

### BACKGROUND OF THE INVENTION

1. Field of the Invention

The present invention is generally directed to computer systems. More particularly, the present invention is directed to improving utilization of resources within a computing system.

2. Background Art

The desire to use a graphics processing unit (GPU) for general computation has become much more pronounced recently due to the GPU's exemplary performance per unit power and/or cost. The computational capabilities for GPUs, generally, have grown at a rate exceeding that of the corresponding central processing unit (CPU) platforms. This growth, coupled with the explosion of the mobile computing market (e.g., notebooks, mobile smart phones, tablets, etc.) and its necessary supporting server/enterprise systems, has been used to provide a specified quality of desired user experience. Consequently, the combined use of CPUs and GPUs for executing workloads with data parallel content is becoming a volume technology.

However, GPUs have traditionally operated in a constrained programming environment, available primarily for the acceleration of graphics. These constraints arose from the fact that GPUs did not have as rich a programming ecosystem as CPUs. Their use, therefore, has been mostly limited to two dimensional (2D) and three dimensional (3D) graphics and a few leading edge multimedia applications, which are already accustomed to dealing with graphics and video application programming interfaces (APIs).

With the advent of multi-vendor supported OpenCL® and DirectCompute®, standard APIs and supporting tools, the limitations of the GPUs in traditional applications has been extended beyond traditional graphics. Although OpenCL and DirectCompute are a promising start, there are many hurdles remaining to creating an environment and ecosystem that allows the combination of a CPU and a GPU to be used as fluidly as the CPU for most programming tasks.

Existing computing systems often include multiple processing devices. For example, some computing systems include both a CPU and a GPU on separate chips (e.g., the CPU might be located on a motherboard and the GPU might be located on a graphics card) or in a single chip package. Both of these arrangements, however, still include significant challenges associated with (i) separate memory systems, (ii) providing quality of service (QoS) guarantees between processes, (iii) programming model, (iv) compiling to multiple target instruction set architectures (ISAs), and (v) efficient scheduling—all while minimizing power consumption.

For example, the discrete chip arrangement forces system and software architects to utilize chip to chip interfaces for each processor to access memory. While these external interfaces (e.g., chip to chip) negatively affect memory latency and power consumption for cooperating heterogeneous processors, the separate memory systems (i.e., separate address spaces) and driver managed shared memory create overhead that becomes unacceptable for fine grain offload.

In another example, due to inefficient scheduling, some processes cannot be easily identified and/or preempted in conventional multiple processing device computing systems. Thus, a rogue process can occupy the GPU hardware for arbitrary amounts of time. In addition, in a system where the GPU is a managed resource under the control of software, the software is burdened with the task of monitoring the utilization of the GPU, and the scheduling of processes for the GPU based on various criteria, or availability of pending GPU tasks in each process.

### SUMMARY OF EMBODIMENTS

What is needed, therefore, is an improved interface to the GPU whereby software has the ability to schedule a single process at a time for execution by the GPU and manage such processes or tasks.

Embodiments of the present invention, in certain circumstances, provide efficient GPU context switch operations for enhancing overall system operational speed. The present invention, in certain circumstances, also enables the offloading of applications from the CPU and so that the offloaded applications can be run on the GPU.

Although GPUs, accelerated processing units (APUs), and general purpose use of the graphics processing unit (GPGPU) are commonly used terms in this field, the expression “accelerated processing device (APD)” is considered to be a broader expression. For example, APD refers to any cooperating collection of hardware and/or software that performs those functions and computations associated with accelerating graphics processing tasks, data parallel tasks, or nested data parallel tasks in an accelerated manner compared to conventional CPUs, conventional GPUs, software and/or combinations thereof.

Embodiments of the disclosed invention provide an APD, a computer readable medium, and a method including receiving a run list comprising one or more processes to run on an APD. Each of the one or more processes is associated with a corresponding independent job command queue. Each of the one or more processes is scheduled to run on the APD based on a criteria associated with each process.

Additional features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention. Various embodiments of the present invention are described below with reference to the drawings, wherein like reference numerals are used to refer to like elements throughout.

FIG. 1A is an illustrative block diagram of a processing system in accordance with embodiments of the present invention.

FIG. 1B is an illustrative block diagram illustration of the accelerated processing device illustrated in FIG. 1A.

FIG. 2 is an illustrative block diagram illustration of a hardware assisted, software-managed task scheduling on an accelerated processing device, according to an embodiment of the present invention.

FIG. 3 is an illustrative flow diagram illustration of a method of hardware assisted, software managed task scheduling on an accelerated processing device, according to an embodiment of the present invention.

### DETAILED DESCRIPTION OF EMBODIMENTS OF THE INVENTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments of the invention” does not require that all embodiments of the invention include the discussed feature, advantage or mode of operation. Alternate embodiments may be devised without departing from the scope of the invention, and well-known elements of the invention may not be described in detail or may be omitted so as not to obscure the relevant details of the invention. In addition, the terminology used herein is for the purpose of describing particular embodiments only and is not intended to be limiting of the invention. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

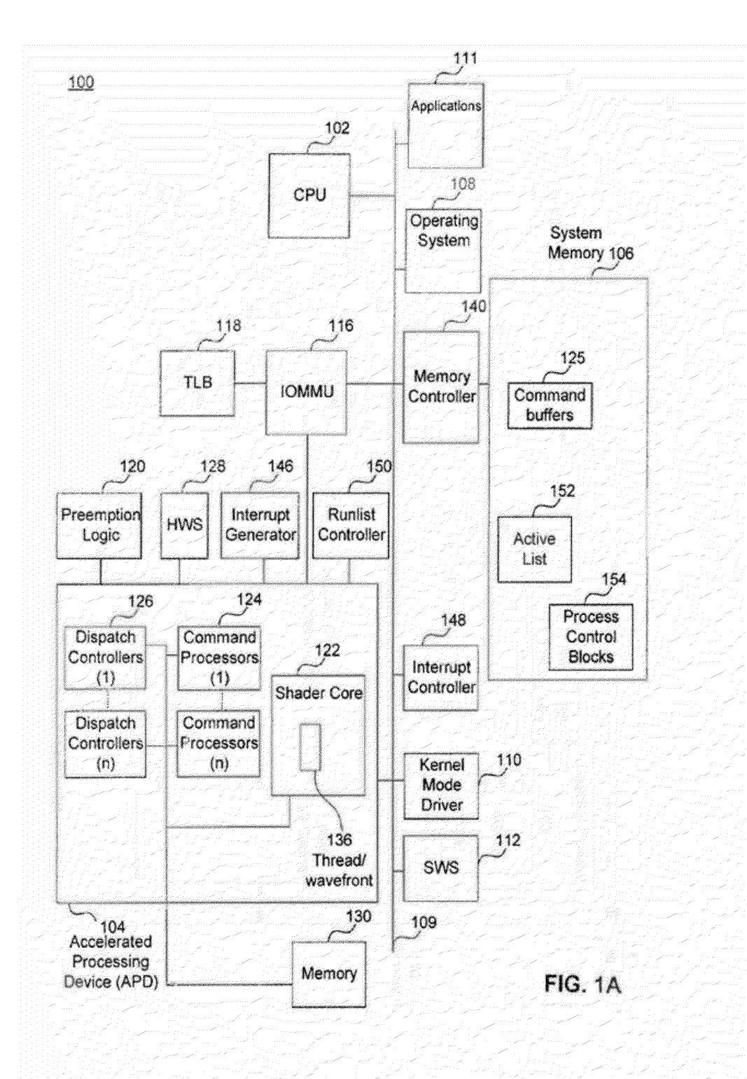

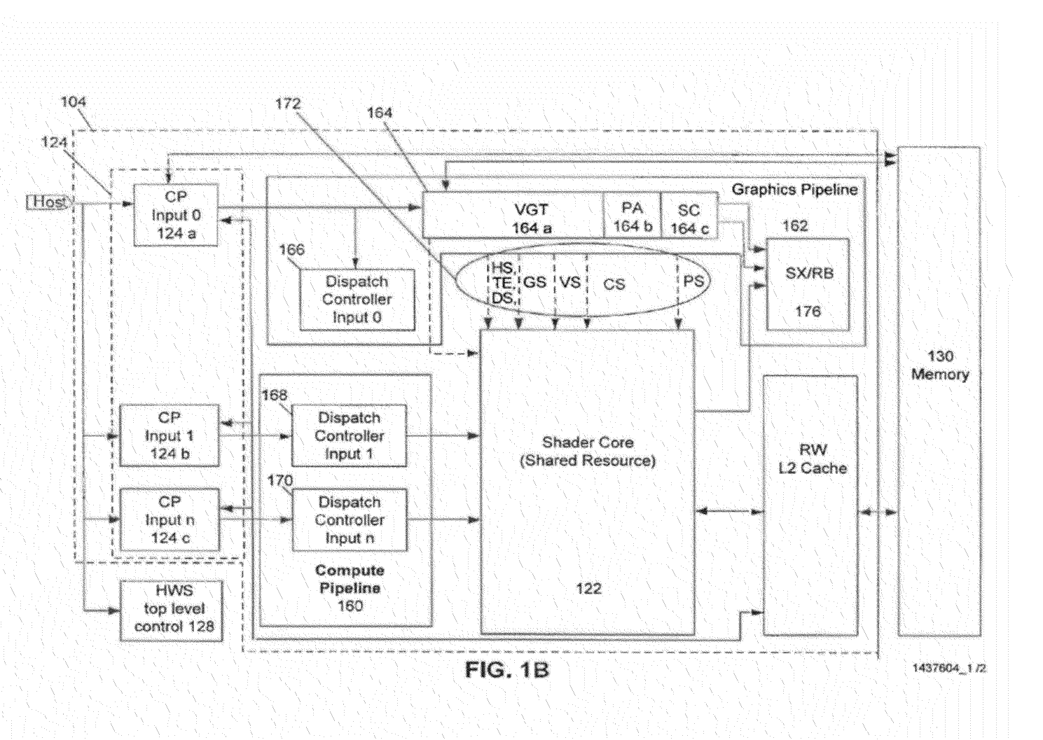

FIG. 1A is an exemplary illustration of a unified computing system 100 including two processors, a CPU 102 and an APD 104. CPU 102 can include one or more single or multi core CPUs. In one embodiment of the present invention, the system 100 is formed on a single silicon die or package, combining CPU 102 and APD 104 to provide a unified programming and execution environment. This environment enables the APD 104 to be used as fluidly as the CPU 102 for some programming tasks. However, it is not an absolute requirement of this invention that the CPU 102 and APD 104 be formed on a single silicon die. In some embodiments, it is possible for them to be formed separately and mounted on the same or different substrates.

In one example, system 100 also includes a memory 106, an operating system 108, and a communication infrastructure 109. The operating system 108 and the communication infrastructure 109 are discussed in greater detail below.

The system 100 also includes a kernel mode driver (KMD) 110, a software scheduler (SWS) 112, and a memory management unit 116, such as input/output memory management unit (IOMMU). Components of system 100 can be implemented as hardware, firmware, software, or any combination thereof. A person of ordinary skill in the art will appreciate that system 100 may include one or more software, hardware, and firmware components in addition to, or different from, that shown in the embodiment shown in FIG. 1A.

In one example, a driver, such as KMD 110, typically communicates with a device through a computer bus or communications subsystem to which the hardware connects. When a calling program invokes a routine in the driver, the driver issues commands to the device. Once the device sends data back to the driver, the driver may invoke routines in the original calling program. In one example, drivers are hardware-dependent and operating-system-specific. They usually provide the interrupt handling required for any necessary asynchronous time-dependent hardware interface.

Device drivers, particularly on modern Microsoft Windows® platforms, can run in kernel-mode (Ring 0) or in user-mode (Ring 3). The primary benefit of running a driver in user mode is improved stability, since a poorly written user mode device driver cannot crash the system by overwriting kernel memory. On the other hand, user/kernel-mode transitions usually impose a considerable performance overhead, thereby prohibiting user mode-drivers for low latency and high throughput requirements. Kernel space can be accessed by user module only through the use of system calls. End user programs like the UNIX shell or other GUI based applications are part of the user space. These applications interact with hardware through kernel supported functions.

CPU 102 can include (not shown) one or more of a control processor, field programmable gate array (FPGA), application specific integrated circuit (ASIC), or digital signal processor (DSP). CPU 102, for example, executes the control logic, including the operating system 108, KMD 110, SWS 112, and applications 111, that control the operation of computing system 100. In this illustrative embodiment, CPU 102, according to one embodiment, initiates and controls the execution of applications 111 by, for example, distributing the processing associated with that application across the CPU 102 and other processing resources, such as the APD 104.

APD 104, among other things, executes commands and programs for selected functions, such as graphics operations and other operations that may be, for example, particularly suited for parallel processing. In general, APD 104 can be frequently used for executing graphics pipeline operations, such as pixel operations, geometric computations, and rendering an image to a display. In various embodiments of the present invention, APD 104 can also execute compute processing operations (e.g., those operations unrelated to graphics such as, for example, video operations, physics simulations, computational fluid dynamics, etc.), based on commands or instructions received from CPU 102.

For example, commands can be considered as special instructions that are not typically defined in the instruction set architecture (ISA). A command may be executed by a special processor such as a dispatch processor, command processor, or network controller. On the other hand, instructions can be considered, for example, a single operation of a processor within a computer architecture. In one example, when using two sets of ISAs, some instructions are used to execute x86 programs and some instructions are used to execute kernels on an APD compute unit.

In an illustrative embodiment, CPU 102 transmits selected commands to APD 104. These selected commands can include graphics commands and other commands amenable to parallel execution. These selected commands, that can also include compute processing commands, can be executed substantially independently from CPU 102.

APD 104 can include its own compute units (not shown), such as, but not limited to, one or more SIMD processing cores. As referred to herein, a SIMD is a pipeline, or programming model, where a kernel is executed concurrently on multiple processing elements each with its own data and a shared program counter. All processing elements execute an identical set of instructions. The use of predication enables work-items to participate or not for each issued command.

In one example, each APD 104 compute unit can include one or more scalar and/or vector floating-point units and/or arithmetic and logic units (ALUs). The API) compute unit can also include special purpose processing units (not shown), such as inverse-square root units and sine/cosine units. In one example, the APD compute units are referred to herein collectively as shader core 122.

Having one or more SIMDs, in general, makes APD 104 ideally suited for execution of data-parallel tasks such as those that are common in, graphics processing.

Some graphics pipeline operations, such as pixel processing, and other parallel computation operations, can require that the same command stream or compute kernel be performed on streams or collections of input data elements. Respective instantiations of the same compute kernel can be executed concurrently on multiple compute units in shader core 122 in order to process such data elements in parallel. As referred to herein, for example, a compute kernel is a function containing instructions declared in a program and executed on an APD compute unit. This function is also referred to as a kernel, a shader, a shader program, or a program.

In one illustrative embodiment, each compute unit (e.g., SIMD processing core) can execute a respective instantiation of a particular work-item to process incoming data. A work-item is one of a collection of parallel executions of a kernel invoked on a device by a command. A work-item can be executed by one or more processing elements as part of a work-group executing on a compute unit.

A work-item is distinguished from other executions within the collection by its global ID and local ID. In one example, a subset of work-items in a workgroup that execute simultaneously together on a SIMD can be referred to as a wavefront 136. The width of a wavefront is a characteristic of the hardware of the compute unit (e.g., SIMD processing core). As referred to herein, a workgroup is a collection of related work-items that execute on a single compute unit. The work-items in the group execute the same kernel and share local memory and work-group barriers.

In the exemplary embodiment, all wavefronts from a workgroup are processed on the same SIMD processing core. Instructions across a wavefront are issued one at a time, and when all work-items follow the same control flow, each work-item executes the same program. Wavefronts can also be referred to as warps, vectors, or threads.

An execution mask and work-item predication are used to enable divergent control flow within a wavefront, where each individual work-item can actually take a unique code path through the kernel. Partially populated wavefronts can be processed when a full set of work-items is not available at wavefront start time. For example, shader core 122 can simultaneously execute a predetermined number of wavefronts 136, each wavefront 136 comprising a multiple work-items.

Within the system 100, APD 104 includes its own memory, such as graphics memory 130 (although memory 130 is not limited to graphics only use). Graphics memory 130 provides a local memory for use during computations in APD 104. Individual compute units (not shown) within shader core 122 can have their own local data store (not shown). In one embodiment, APD 104 includes access to local graphics memory 130, as well as access to the memory 106. In another embodiment, APD 104 can include access to dynamic random access memory (DRAM) or other such memories (not shown) attached directly to the APD 104 and separately from memory 106.

In the example shown, APD 104 also includes one or “n” number of command processors (CPs) 124. CP 124 controls the processing within APD 104. CP 124 also retrieves commands to be executed from command buffers 125 in memory 106 and coordinates the execution of those commands on APD 104.

In one example, CPU 102 inputs commands based on applications 111 into appropriate command buffers 125. As referred to herein, an application is the combination of the program parts that will execute on the compute units within the CPU and APD.

A plurality of command buffers 125 can be maintained with each process scheduled for execution on the APD 104.

CP 124 can be implemented in hardware, firmware, or software, or a combination thereof. In one embodiment, CP 124 is implemented as a reduced instruction set computer (RISC) engine with microcode for implementing logic including scheduling logic.

APD 104 also includes one or “n” number of dispatch controllers (DCs) 126. In the present application, the term dispatch refers to a command executed by a dispatch controller that uses the context state to initiate the start of the execution of a kernel for a set of workgroups on a set of compute units. DC 126 includes logic to initiate workgroups in the shader core 122. In some embodiments, DC 126 can be implemented as part of CP 124.

System 100 also includes a hardware scheduler (HWS) 128 for selecting a process from a run list 150 for execution on APD 104. HWS 128 can select processes from run list 150 using round robin methodology, priority level, or based on other scheduling policies. The priority level, for example, can be dynamically determined. HWS 128 can also include functionality to manage the run list 150, for example, by adding new processes and by deleting existing processes from run-list 150. The run list management logic of HWS 128 is sometimes referred to as a run list controller (RLC).

In various embodiments of the present invention, when HWS 128 initiates the execution of a process from RLC 150, CP 124 begins retrieving and executing commands from the corresponding command buffer 125. In some instances, CP 124 can generate one or more commands to be executed within APD 104, which correspond with commands received from CPU 102. In one embodiment, CP 124, together with other components, implements a prioritizing and scheduling of commands on APD 104 in a manner that improves or maximizes the utilization of the resources of APD 104 and/or system 100.

APD 104 can have access to, or may include, an interrupt generator 146. Interrupt generator 146 can be configured by APD 104 to interrupt the operating system 108 when interrupt events, such as page faults, are encountered by APD 104. For example, APD 104 can rely on interrupt generation logic within IOMMU 116 to create the page fault interrupts noted above.

APD 104 can also include preemption and context switch logic 120 for preempting a process currently running within shader core 122. Context switch logic 120, for example, includes functionality to stop the process and save its current state (e.g., shader core 122 state, and CP 124 state).

As referred to herein, the term state can include an initial state, an intermediate state, and/or a final state. An initial state is a starting point for a machine to process an input data set according to a programming order to create an output set of data. There is an intermediate state, for example, that needs to be stored at several points to enable the processing to make forward progress. This intermediate state is sometimes stored to allow a continuation of execution at a later time when interrupted by some other process. There is also final state that can be recorded as part of the output data set

Preemption and context switch logic 120 can also include logic to context switch another process into the APD 104. The functionality to context switch another process into running on the APD 104 may include instantiating the process, for example, through the CP 124 and DC 126 to run on APD 104, restoring any previously saved state for that process, and starting its execution.

Memory 106 can include non-persistent memory such as DRAM (not shown). Memory 106 can store, e.g., processing logic instructions, constant values, and variable values during execution of portions of applications or other processing logic. For example, in one embodiment, parts of control logic to perform one or more operations on CPU 102 can reside within memory 106 during execution of the respective portions of the operation by CPU 102.

During execution, respective applications, operating system functions, processing logic commands, and system software can reside in memory 106. Control logic commands fundamental to operating system 108 will generally reside in memory 106 during execution. Other software commands, including, for example, KMD 110 and software scheduler 112 can also reside in memory 106 during execution of system 100.

In this example, memory 106 includes command buffers 125 that are used by CPU 102 to send commands to APD 104. Memory 106 also contains process lists and process information (e.g., active list 152 and process control blocks 154). These lists, as well as the information, are used by scheduling software executing on CPU 102 to communicate scheduling information to APD 104 and/or related scheduling hardware. Access to memory 106 can be managed by a memory controller 140, which is coupled to memory 106. For example, requests from CPU 102, or from other devices, for reading from or for writing to memory 106 are managed by the memory controller 140.

Referring back to other aspects of system 100, IOMMU 116 is a multi-context memory management unit.

As used herein, context can be considered the environment within which the kernels execute and the domain in which synchronization and memory management is defined. The context includes a set of devices, the memory accessible to those devices, the corresponding memory properties and one or more command-queues used to schedule execution of a kernel(s) or operations on memory objects.

Referring back to the example shown in FIG. 1A, IOMMU 116 includes logic to perform virtual to physical address translation for memory page access for devices including APD 104. IOMMU 116 may also include logic to generate interrupts, for example, when a page access by a device such as APD 104 results in a page fault. IOMMU 116 may also include, or have access to, a translation lookaside buffer (TLB) 118. TLB 118, as an example, can be implemented in a content addressable memory (CAM) to accelerate translation of logical (i.e., virtual) memory addresses to physical memory addresses for requests made by APD 104 for data in memory 106.

In the example shown, communication infrastructure 109 interconnects the components of system 100 as needed. Communication infrastructure 109 can include (not shown) one or more of a peripheral component interconnect (PCI) bus, extended PCI (PCI-E) bus, advanced microcontroller bus architecture (AMBA) bus, accelerated graphics port (AGP), or other such communication infrastructure. Communications infrastructure 109 can also include an Ethernet, or similar network, or any suitable physical communications infrastructure that satisfies an application's data transfer rate requirements. Communication infrastructure 109 includes the functionality to interconnect components including components of computing system 100.

In this example, operating system 108 includes functionality to manage the hardware components of system 100 and to provide common services. In various embodiments, operating system 108 can execute on CPU 102 and provide common services. These common services can include, for example, scheduling applications for execution within CPU 102, fault management, interrupt service, as well as processing the input and output of other applications.

In some embodiments, based on interrupts generated by an interrupt controller, such as interrupt controller 148, operating system 108 invokes an appropriate interrupt handling routine. For example, upon detecting a page fault interrupt, operating system 108 may invoke an interrupt handler to initiate loading of the relevant page into memory 106 and to update corresponding page tables.

Operating system 108 may also include functionality to protect system 100 by ensuring that access to hardware components is mediated through operating system managed kernel functionality. In effect, operating system 108 ensures that applications, such as applications 111, run on CPU 102 in user space. Operating system 108 also ensures that applications 111 invoke kernel functionality provided by the operating system to access hardware and/or input/output functionality.

By way of example, applications 111 include various programs or commands to perform user computations that are also executed on CPU 102. CPU 102 can seamlessly send selected commands for processing on the APD 104. In one example, KMD 110 implements an application program interface (API) through which CPU 102, or applications executing on CPU 102 or other logic, can invoke APD 104 functionality. For example, KMD 110 can enqueue commands from CPU 102 to command buffers 125 from which APD 104 will subsequently retrieve the commands. Additionally, KMD 110 can, together with SWS 112, perform scheduling of processes to be executed on APD 104. SWS 112, for example, can include logic to maintain a prioritized list of processes to be executed on the APD.

In other embodiments of the present invention, applications executing on CPU 102 can entirely bypass KMD 110 when enqueuing commands.

In some embodiments, SWS 112 maintains an active list 152 in memory 106 of processes to be executed on APD 104. SWS 112 also selects a subset of the processes in active list 152 to be managed by HWS 128 in the hardware. Information relevant for running each process on APD 104 is communicated from CPU 102 to APD 104 through process control blocks (PCB) 154.

Processing logic for applications, operating system, and system software can include commands specified in a programming language such as C and/or in a hardware description language such as Verilog, RTL, or netlists, to enable ultimately configuring a manufacturing process through the generation of maskworks/photomasks to generate a hardware device embodying aspects of the invention described herein.

A person of skill in the art will understand, upon reading this description, that computing system 100 can include more or fewer components than shown in FIG. 1A. For example, computing system 100 can include one or more input interfaces, non-volatile storage, one or more output interfaces, network interfaces, and one or more displays or display interfaces.

FIG. 1B is an embodiment showing a more detailed illustration of APD 104 shown in FIG. 1A. In FIG. 1B, CP 124 can include CP pipelines 124a, 124b, and 124c. CP 124 can be configured to process the command lists that are provided as inputs from command buffers 125, shown in FIG. 1A. In the exemplary operation of FIG. 1B, CP input 0 (124a) is responsible for driving commands into a graphics pipeline 162. CP inputs 1 and 2 (124b and 124c) forward commands to a compute pipeline 160. Also provided is a controller mechanism 166 for controlling operation of HWS 128.

In FIG. 1B, graphics pipeline 162 can include a set of blocks, referred to herein as ordered pipeline 164. As an example, ordered pipeline 164 includes a vertex group translator (VGT) 164a, a primitive assembler (PA) 164b, a scan converter (SC) 164c, and a shader-export, render-back unit (SX/RB) 176. Each block within ordered pipeline 164 may represent a different stage of graphics processing within graphics pipeline 162. Ordered pipeline 164 can be a fixed function hardware pipeline. Other implementations can be used that would also be within the spirit and scope of the present invention.

Although only a small amount of data may be provided as an input to graphics pipeline 162, this data will be amplified by the time it is provided as an output from graphics pipeline 162. Graphics pipeline 162 also includes DC 166 for counting through ranges within work-item groups received from CP pipeline 124a. Compute work submitted through DC 166 is semi-synchronous with graphics pipeline 162.

Compute pipeline 160 includes shader DCs 168 and 170. Each of the DCs 168 and 170 is configured to count through compute ranges within work groups received from CP pipelines 124b and 124c.

The DCs 166, 168, and 170, illustrated in FIG. 1B, receive the input ranges, break the ranges down into workgroups, and then forward the workgroups to shader core 122.

Since graphics pipeline 162 is generally a fixed function pipeline, it is difficult to save and restore its state, and as a result, the graphics pipeline 162 is difficult to context switch. Therefore, in most cases context switching, as discussed herein, does not pertain to context switching among graphics processes. An exception is for graphics work in shader core 122, which can be context switched.

After the processing of work within graphics pipeline 162 has been completed, the completed work is processed through a render back unit 176, which does depth and color calculations, and then writes its final results to memory 130.

Shader core 122 can be shared by graphics pipeline 162 and compute pipeline 160. Shader core 122 can be a general processor configured to run wavefronts. In one example, all work within compute pipeline 160 is processed within shader core 122. Shader core 122 runs programmable software code and includes various forms of data, such as state data.

In embodiments described herein, methods and systems relating to hardware assisted, software managed task scheduling are provided. For example, embodiments described herein relate to an accelerated processing device controlling the execution of a set of given processes. In an embodiment, the accelerated processing device is given a set of processes defined by software. In addition, each process includes an associated priority value. In this manner, the accelerated processing device controls the execution of the processes based on the directives from the software without involving the software in the execution of each process, thereby freeing resources.

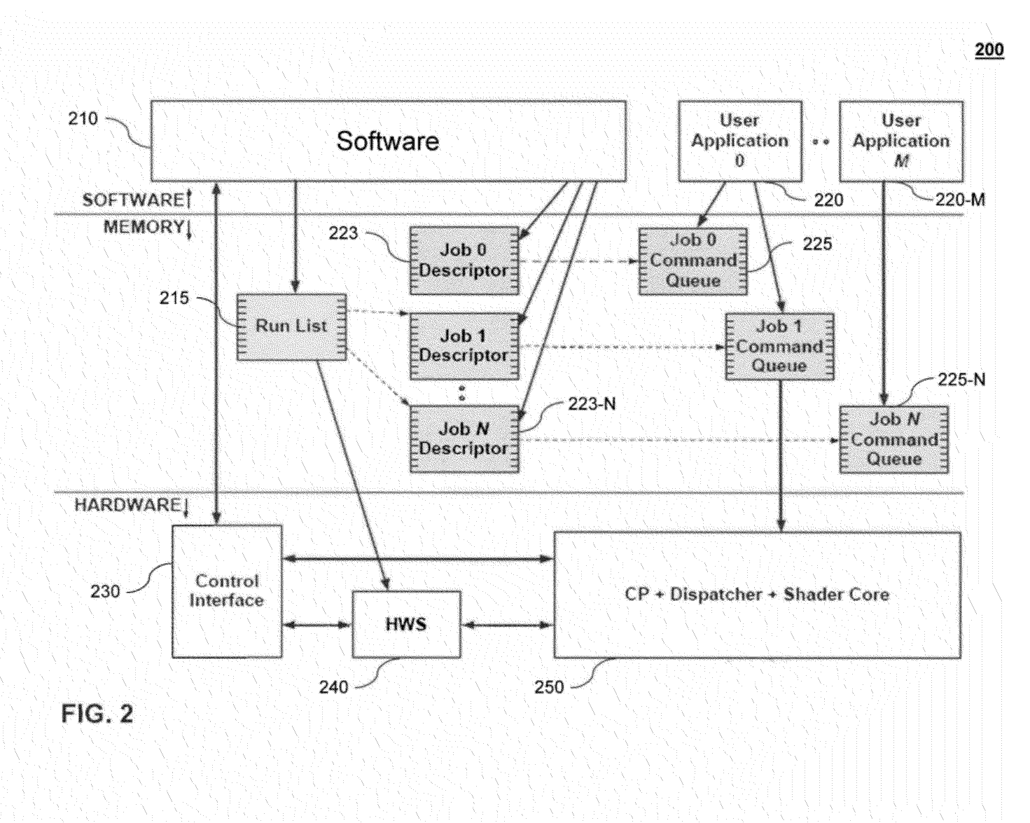

FIG. 2 is a block diagram illustration of a hardware and software scheduling system 200 for scheduling processes within an accelerated processing device, according to an embodiment of the invention. System 200 includes software 210, run list 215, user applications 220 through 220-M, job descriptors 223 through 233-N, job command queues 225 through 225-N, a control interface 230, a HWS 240, and a control processor/dispatch/shader core 250 (hereinafter referred to as control processor 250).

Software 210 contains a software scheduler component that provides a list of processes that are to be run by the accelerated processing device. The list of processes is stored within run list 215. Run list 215 can be periodically updated and modified by software 210 at any time. The contents of run list 215 dictate to HWS 240 which processes are to be run by control processor 250. Run list 215 contains a set of entries corresponding to a set of the accelerated processing device jobs in the system wherein a scheduling algorithm may be applied to the jobs or processes. Further, the jobs or processes in run list 215 can include both graphics processes as well as compute processes.

Each entry in run list 215 points to a job descriptor in job descriptors 223 through 223-N, which in turn each contain a pointer to a corresponding job command queue in job command queues 225 through 225-N. Whenever a job, or process, in run list 215 is selected by HWS 240, user commands from the corresponding job command queue is fetched and executed by control processor 250. Further, each user application in user applications 220 through 220-M is associated with one or more job command queues 225 through 225-N where the user application is the source of a particular job.

Control processor 250 may execute a particular job until that job is done, or if a particular threshold is reached, such as a time limit imposed for execution of a particular job. In addition, control interface 230 responds to commands from software 210, where such commands can control the execution of one or more jobs. Software 210 may issue commands including instructions to stop a currently executing job; save the context state of the stopped job; load a new job on the accelerated processing device, while, if appropriate, restoring its saved state if the new job had been preempted previously; and start executing the new job. Software 210 issues such commands to control interface 230, which in turn directs HWS 240 to execute the specified command. However, control processor 250, in an embodiment, only executes a single job or process at any point in time. In such an embodiment multiple jobs are executed sequentially.

Control processor 250 receives its instructions from a job command queue in job command queues 225 through 225-N. Control processor 250 also has the ability to enter a reduced power state if it senses that the currently accessed command queue is empty in order to conserve power.

Software 210, through access to run list 215 as described above, and with access to control interface 230, has the ability to monitor the resource utilization of the accelerated processing device and make any adjustments that software 210 may deem appropriate. Such monitoring can be based on a particular single process within run list 215 or on multiple processes within run list 215.

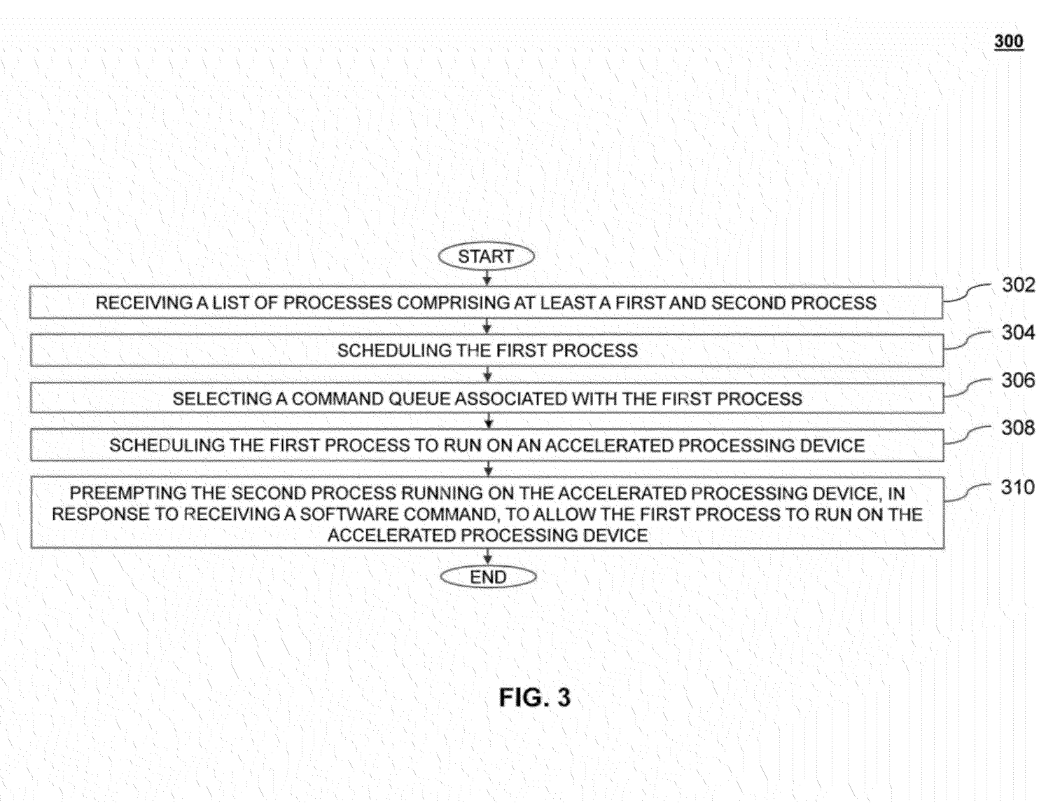

FIG. 3 is a flowchart 300 of an exemplary method of scheduling processes within an accelerated processing device, according to an embodiment of the invention. Flowchart 300 will be described with reference to the embodiment of FIG. 2, but is not limited to that embodiment. The step of flowchart 300 does not have to occur in the order shown. The steps of flowchart 300 will be described below.

In step 302, a list of processes comprising at least a first and second process is received. In an example, software, such as that represented by software 210 in FIG. 2, will generate a list of processes that are to be run by the accelerated processing device. The list of processes, in an embodiment, is contained within run list 215, and may also contain priority information associated with each process.

In step 304, the scheduling of the first process is performed. The task can be of a type, e.g., a graphics task, such as a pixel task, or a compute task, e.g., a non-graphics based task. In an example, software, such as that represented by software 210 in FIG. 2, will issue the command that schedules the first process. In an embodiment, software 210 may issue multiple scheduling commands, each command associated with a process. Such commands may also contain scheduling information for each process, such as a priority level, the maximum time a process may run, or any other associated scheduling information. In an embodiment, such scheduling commands may be stored in a list, such as run list 215. Further, in an embodiment, the received scheduling commands may be edited, such as being removed from run list 215, or information associated with a scheduling command may be changed, e.g., priority level could be modified.

In step 306, the first process is associated with a selected command queue. For example, when multiple processes are contained within run list 215, each process is associated with a command queue, such as a command queue in command queues 225 through 225-N. In addition, user commands from the selected command queue are fetched for execution, such as by control processor 250, when the process is scheduled to run.

In an embodiment, step 306 includes monitoring the selected command queue to detect the presence of a command to schedule a process. In an embodiment, if such monitoring detects that there are no commands present in the selected command queue, the system may be placed into a reduced power state. Step 306 may also include where such monitoring allows software, such as an operating system, to monitor resource utilization of the accelerated processing device. Such monitoring can be directed to a single particular process, or multiple processes.

In step 308, the first process is scheduled to run on a graphics processing unit. As mentioned above, a process can be scheduled to run based on a priority level associated with the process. When the process is scheduled to run, in an embodiment, control processor 250 will execute the instructions contained within the command queue associated with the process. The instructions within the command queue may continue to be executed until the process is completed, or the process is preempted.

In step 310, a second process that is currently being executed, e.g., by control processor 250, is preempted, in response to receiving a software command, to allow the first process to run on the accelerated processing device. Step 310 may occur because the first process is of a higher priority than the second process, or because software 210 has issued a command to execute the first process. The preemption of a process can include stopping the currently executing job, e.g., stopping the second process; saving the context state of the second process once the second process has been stopped; and loading the first process on the accelerated processing device. In the instance that the first process had been previously running on the accelerated processing device and had been preempted, step 308 would include the restoring of the saved state associated with the first process at the time it was preempted. Such a restoration of the saved state allows the first process to continue being executed at the point it was preempted. As shown in FIG. 2, software 210 may issue preemption commands to control interface 230, which in turn direct HWS 240 to implement the specified command to stop a process, saved the associated context state of the stopped process, start a new process, and if the new process had been previously preempted, to restore the context state of the new process prior to starting its execution.

In an embodiment, the execution of instructions associated with a process are done sequentially such that only a single process is being executed by the accelerated processing device at any particular time.

### CONCLUSION

The Summary and Abstract sections may set forth one or more but not all exemplary embodiments of the present invention as contemplated by the inventor(s), and thus, are not intended to limit the present invention and the appended claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
scheduling a first process;
scheduling the first process to run on an accelerated processing device (APD); and
preempting a second process running on the APD, in response to receiving a command, to allow the first process to run on the APD.

2. The method of claim 1, wherein the first process is one of a graphics process and a compute process.

3. The method of claim 1, wherein the preempting comprises:
stopping the second process running on the APD; and
saving of a context state associated with the second process.

4. The method of claim 3, wherein, after the first process has completed, the preempting further comprises:
restoring the context state of the second process; and
restarting the second process to run on the APD.

5. The method of claim 1, further comprising:
monitoring the command queue for a new command.

6. The method of claim 1, further comprising:
placing the APD into a reduced power state if the command queue is empty.

7. The method of claim 1, further comprising:
allowing an operating system to monitor a resource utilization of the APD.

8. The method of claim 7, wherein the monitoring is based on the first or second process.

9. An accelerated processing device (APD), comprising:
a shader core configured to run a first and second process contained within a list of processes;
a dispatcher configured to receive a command to schedule the first process, wherein the first process is associated with a command queue; and
a scheduler configured to preempt the second process, in response to receiving a software command, to schedule the first process to run on the APD.

10. The system of claim 9, wherein the first process is one of a graphics process and a compute process.

11. The system of claim 9, wherein the scheduler is configured to preempt by:
stopping the second process running on the APD; and
saving of a context state associated with the second process.

12. The system of claim 11, wherein, after the first process has completed, the scheduler is configured to:
restore the context state of the second process; and
restart the second process to run on the APD.

13. The system of claim 9, wherein the scheduler is configured to monitor the command queue for a new command.

14. The system of claim 9, wherein the shader core is configured to place the APD into a reduced power state if the command queue is empty.

15. The system of claim 9, wherein the shader core is configured to allow an operating system to monitor a resource utilization of the APD.

16. A computer readable medium storing instructions, wherein execution of the instructions causes a method comprising:
receiving a list of processes comprising at least a first and second process;
scheduling the first process;
selecting a command queue associated with the first process;
scheduling the first process to run on an accelerated processing device; and
preempting the second process running on the graphic processing device, in response to receiving a software command, to allow the first process to run on the graphic processing device.
